(19) United States
(12) Patent Application Publication
(10) Pub. No.: US 2007/0159337 A1
(43) Pub. Date: Jul. 12, 2007

(54) Modular RFID tag

(75) Inventors: Steven M. Tethrake, Collierville, TN (US); Robert Varner, Germantown, TN (US); Roger Ousley, Southaven, MS (US); Jeffrey H. Nycz, Collierville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SDGI HOLDINGS, INC.

(21) Appl. No.: 11/330,195

(22) Filed: Jan. 12, 2006

(51) Int. Cl. G08B 13/14

(52) U.S. Cl. 340/572.8

(57) ABSTRACT

A modular RFID tag that includes at least first and second tag portions that are mechanically connected to one another. A portion of the RFID transponder circuit resides in each portion of the tag. When the two tag portions are connected they form a substantially cylindrically-shaped structure. When the two tag portions are connected to one another, a conductive pin attached to one portion engages the other portiont to complete the circuit. Each portion may include a deformable layer on an inside surface that allows the modular tag to be attached to items of different dimensions and cross-sectional profiles.

### FIELD OF THE INVENTION

Embodiments of the invention generally relate to radio frequency identification systems, and more particularly to a modular RFID transponder tag for easy attachment, detachment and reattachment to a variety of different shaped devices and equipment. The modular RFID transponder tag may be particularly suited for application to medical and surgical devices, hand tools and other equipment.

### DESCRIPTION OF RELATED ART

Electronic data carrying memory devices are known. These devices provide a means for tracking and providing information about tools, equipment, inventory and other items. Memory devices permit linking of large amounts of data with an object or item. They typically include a memory and logic in the form of an integrated circuit (“IC”) and a mechanism for transmitting data to and/or from the product or item attached to the memory device. An example of such a memory device-based product identification technology is radio frequency identification (RFID).

Radio frequency identification (RFID) systems use an RF field generator (reader) to wirelessly extract identification information (i.e., UPC, product name, etc.) contained in RFID transponder attached to various products and objects. RFID tags are miniature electronic circuits that typically consist of a coil that acts as an antenna and a small silicon-based microprocessor with a memory, all encapsulated in a protective material. RFID tags store identification information, usually in the form of an identification number that corresponds to an object or item to which the tag is attached. This number may be used to index a database containing price, product name, manufacture and/or other information. When a transponder tag enters an RF field generated by a reader device, the circuit of the tag becomes energized causing the processor to perform a data operation, usually by emitting a signal containing the processor's stored information. The basic structure and operation of RFID tags can be found in, for example, U.S. Pat. Nos. 4,075,632, 4,360,801, 4,390,880, 4,739,328 and 5,030,807, the disclosures of which are hereby incorporated by reference in their entirety.

RFID tags generally are formed on a substrate, such as, for example, paper, and can include analog RF circuits, digital logic, and memory circuits. RFID tags also can include a number of discrete components, such as capacitors, transistors, and diodes. RFID tags are categorized as either active or passive. Active tags have their own discrete power source such as a battery. When an active tag enters an RF field it is turned on and then emits a signal containing its stored information. Passive tags do not contain a power source. Rather, they become inductively or capacitively charged when they enter an RF field. Once the RF field has activated the passive circuit, the tag emits a signal containing its stored information. Passive RFID tags usually include an analog circuit that detects and decodes the interrogating RF signal and that provides power from the RF field to a digital circuit in the tag. The digital circuit generally executes all of the data functions of the RFID tag, such as retrieving stored data from memory and causing the analog circuit to modulate to the RF signal to transmit the retrieved data. In addition to retrieving and transmitting data previously stored in the memory, both passive and active dynamic RFID tags can permit new or additional information to be written to a portion of the RFID tag's memory, or can permit the RFID tag to manipulate data or perform some additional functions.

Though originally invented to track feeding of cattle, RFID tags are today utilized in a variety of applications including retail security, inventory management, and even computerized checkout. With the price of RFID tags now reaching as low as 5 cents per tag, and because of reductions in size due to an overall trend towards miniaturization in circuit design, RFID tags currently are being applied to many types of products, both at the consumer level as well as in manufacturing processes. RFID tags enable manufacturers to wirelessly track products from the manufacturing stage to the point-of-sale. They provide a robust, cost effective, efficient and accurate solution to inventory tracking and management.

Current commercially available RFID tags, both active and passive, generally come in one of two configurations: inductively or capacitively coupled. Inductively coupled tags, the first type of RFID tags developed, consist of a silicon-based microprocessor, a metal coil wound into a circular pattern which serves as the tag's antenna, and an encapsulating material that wraps around the chip and coil. These tags are powered by an electromagnetic field generated by the tag reader. The tag's antenna picks up the electromagnetic energy which in turn powers the chip. The tag then modulates the electromagnetic field in order to transmit data back to the reader. Despite advances in silicon manufacturing processes, inductively coupled tags have remained relatively expensive due to the coil antenna and the manufacturing process required to wind the coil around the surface of the tag.

The second type of RFID tags, capacitively coupled tags, eliminate the metal coil, consisting instead of a silicon microprocessor, paper substrate, and a conductive carbon ink that is applied to the paper substrate through a conventional printing means. By using conductive ink and conventional printing processes, a relatively low cost, disposable tag can be created that is easily integrated into conventional product labels.

RFID tags are rapidly becoming the preferred method of inventory tracking in retail and distribution applications and will likely surpass bar codes as the preferred point-of-sale checkout identifier. Large retail chains such as WALMART Corporation are already requiring their suppliers to utilize RFID tags for tracking shipments. RFID tags have significant advantages over bar code labels. For example, bar codes are limited in size by resolution limitations of bar code scanners, and the amount of information that the symbols can contain is limited by the physical space constraints of the label. Therefore, some objects may be unable to accommodate bar code labels because of their size and physical configuration. In contrast, RFID tags store their information in digital memory. Thus, they can be made much smaller than bar code tags.

Another advantage of RFID tags over bar codes is that bar code readers requires line of sight in order to read the reflection pattern from a bar code. As labels become worn or damaged, they can no longer be read with the bar code scanner. Also, because a person operating the bar code scanner must physically orient either the scanner or the product to achieve line of sight on each item being scanned, items must be scanned one at a time resulting in prolonged scan time. RFID tags, on the other hand, are read through radio waves, which do no require line of sight because they are able to penetrate light impermeable materials. This not only eliminates the line of sight requirement, but also allows rapid identification of a batch of tagged products.

Yet another relative advantage of RFID tags over bar code labels is that for dynamic RFID tags, the information stored in the tag may be updated using a writing device to wirelessly transmit the new information to be stored. Updating information in bar code tags typically requires printing a new tag to replace the old.

One problem associated with the use of RFID tags, which also is common to bar code tags, is that it can be difficult to securely attach the tags to various goods and products. As discussed above, capacitively coupled RFID tags usually are printed on a paper substrate and then attached to various items using an adhesive bonding. However, in some applications, a paper tag may not hold up to the rigors of the environment in which the product is used. For example, in the field of medical equipment, and in particular, surgical instruments and surgical instrument storage and sterilization systems, items are routinely exposed to environments containing various combinations of high temperatures, high pressure and liquid, vaporous and/or gaseous chemical sterilants. Even in non-medical environments, hand tools and other equipment may be subjected to harsh physical conditions through ordinary use. Over time, a paper RFID tag would not provide reliable performance under these harsh conditions. More rugged RFID tags have been developed as a potential solution to this problem. An example of a rugged RFID tag is provided in U.S. Pat. No. 6,255,949, the disclosure of which is hereby incorporated by reference in its entirety. The '949 patent discloses an RF transponder tag surrounded by a thermally resistant polymer and encapsulated in a hardened case. Because radio frequency waves can penetrate such materials, performance of the tag is not degraded by the case or polymer. Such a configuration prevents damage to the transponder tag if exposed to high temperature environments.

While making the tag enclosure more rugged may sometimes protect the internal components of the tag, this still does not solve the problem of keeping the tag securely attached, particularly in harsh environments. As discussed above, substrate based tags, even ruggedized tags, are typically mounted using an adhesive. This presents at least two problems for the application of tags exposed to harsh environments. First, adhesives will break down and lose their adhesive property when they are exposed to heat and moisture. This limits their usage to dry “friendly” environments. Second, adhesives typically require a flat surface on which to mount the RFID tags. This precludes the mounting of tags onto devices, equipments, or containers that do not have a flat surface of sufficient dimensions. Furthermore, many items do not have geometrically shaped portions sufficiently large to accommodate such a substrate based tag. Thus, for at least these reasons, adhesives do not provide an effective solution for attaching RFID tags in certain environments.

A proposed solution to the above described attachment problem has been to integrate the RFID tag into a bracelet or strap. This can be particularly useful for patient or personal monitoring systems. U.S. Pat. No. 6,104,295 describes such an electronic band having an integral RFID tag. However, a problem with this solution is that the band's width will preclude application of the bracelet to small items. Also, because the portion of the band defined by the tag is rigid, this will dictate the minimum width that the band strap can be adjusted to. Thus, for items having a small diameter, only a loose fitting will be possible.

As noted above, the problems of attachment as well as ruggedization may particularly acute in the field of medical equipment and instruments, but may also be acute in other areas as well including construction, manufacturing, repair, etc. Tools and equipment used in these fields are regularly exposed to harsh environments in their ordinary course of use, whether through sterilization or simply the environments, applications and conditions in which they are used. Also, this equipment is typically expensive and highly mobile. Thus, there is a strong need for accurate and efficient tracking that does not impede or interfere with the utility of these tools and equipment.

The description herein of various advantages and disadvantages associated with known apparatus, methods, and materials is not intended to limit the scope of the invention to their exclusion. Indeed, various embodiments of the invention may include one or more of the known apparatus, methods, and materials without suffering from their disadvantages.

### SUMMARY OF THE INVENTION

Based on the foregoing, it would be desirable to provide an RFID tag that overcomes or ameliorates some or all of the shortcomings of conventional tags. In particular, it would be desirable to provide an RFID tag that can withstand the rigors of sterilization and other harsh environments and that can also be cheaply and easily used with new as well as existing instruments and equipment and that can be securely attached to objects that are devoid of flat surfaces.

Thus, it is a feature of various embodiments of the invention to provide an RFID tag that is sufficiently ruggedized to permit use of the tag in moist, heated, cooled, pressurized or other destructive environments. It is a further feature of various embodiments of the invention to provide an RFID tag that does not require modification to existing objects to be retroactively compatible.

Another feature of various embodiments of the invention provides an RFID tag that can be attached to objects of differing shapes. An additional feature of various embodiments of the invention provides an RFID tag that is operable to be affixed to various objects without adhesives.

To achieve the above-noted features, and in accordance with the purposes as embodied and broadly described herein, one exemplary embodiment provides a modular RFID tag. The modular RFID tag according to this embodiment comprises a first portion having a first connecting means, a second portion having a second reciprocal connecting means and an electrical connecting means connecting the first portion to the second portion when the tag is mounted on an item to be identified, and further wherein an RFID transponder circuit is in electrical connection with the electrical connecting means.

In accordance with another exemplary embodiment, a modular RFID tag is provided. The modular RFID tag according to this embodiment comprises a first portion having a first connector, a second portion having a second connector adapted to mate with the first connector to provide a mechanical connection, and an RFID transponder circuit, wherein each of the first and second portions comprise and antenna encapsulated therein that is interconnected by a conductive pin attached to the first portion that is adapted to penetrate the second portion when the first and second portions are connected to each other.

In yet a further exemplary embodiment, a modular RFID tag is provided. The modular RFID tag according to this embodiment comprises a first portion, a second portion, a flexible hinge connecting the first portion to the second portion, and an RFID transponder circuit including a conductive pin, wherein the conductive pin electrically couples antenna portion in the first and second portion to the transponder circuit when the first and second portions are connected to each other.

In accordance with a further exemplary embodiment, a method of manufacturing a modular RFID tag is provided. The method according to this embodiment comprises forming a first flexible portion having a first mechanical connector, forming a second flexible portion having a second reciprocal mechanical connector adapted to mate with the first mechanical connector, and embedding portion of an RFID transponder circuit in both the first portion and the second portion such that when the first portion is connected to the second portion by the first and second mechanical connectors, a conductive pin attached to the first portion establishes electrical connection between the two portions to form a unitary circuit.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

Purposes and advantages of the embodiments will be apparent to those of ordinary skill in the art from the following detailed description in conjunction with the appended drawings in which like reference characters are used to indicate like elements, and in which:

FIG. 1 is a perspective view of an exemplary modular RFID tag shown as attached to an object according to at least one embodiment of the invention;

FIG. 2 is a perspective view of modular RFID tag shown in an disengaged configuration attached to a object according to at least one embodiment of the invention;

FIG. 3 is a perspective view of another modular RFID tag shown attached to an object according to at least one embodiment of the invention;

FIG. 4 is a perspective view of a portion of the RFID tag of FIG. 3 shown in an unattached configuration according to at least one embodiment of the invention;

FIG. 5 is a side view of the portion of the tag depicted in FIG. 4;

FIG. 6 is a close up view of a modular RFID tag such as that depicted in FIGS. 3-5 shown in an unattached and disengaged configuration according to at least one embodiment of the invention;

FIG. 7 is a close up perspective view of another modular RFID tag according to at least one embodiment of the invention; and

FIGS. 8 and 9 are perspective view of tools that are tagged with a modular RFID tag in accordance with various embodiments of the invention.

### DETAILED DESCRIPTION

The following description is intended to convey a thorough understanding of the embodiments described by providing a number of specific embodiments and details involving modular RFID transponder tags and method of manufacturing modular RFID transponder tags. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

As used herein, the expressions “RFID tag” and “RFID transponder tag” will refer to any active or passive type of electronic data storage device, read-only or read and write, that is wirelessly activated in the presence of a radio frequency (RF) field, including any currently available inductively coupled RFID tags, capacitively coupled RFID tags and even future RF-type tags not yet available. This includes tags operating in the 125 kHz, 13.56 MHz, 868-927 MHz, 2.45 GHz and 5.8 GHz frequency bands as well as other suitable frequency bands. Also, the tag may be a silicon-type IC tag, a printed tag printed with a conductive ink-based printing process or a tag formed by other suitable means.

As used herein, the expressions and terms “surgical instrument,” “medical instrument,” “instrument,” or “device” will refer to any type of surgical or medical instrument or portable equipment or device to which it may be desirable to attach an RFID tag. Though the specification is written in the context of medical and/or surgical instruments, it should be appreciated that the modular RFID tag of the embodiments may be used with a variety of different items to be identified as shape and design constraints permit, including tools and equipment in other fields unrelated to the medical field. This may include hand tools or other objects and/or equipment that are used in construction, manufacturing, maintenance or other industries. All of these uses are within the intended scope of the embodiments of the invention.

Through out this description, the expression “modular RFID tag” will be given broad meaning including, but not limited to, any type of RFID transponder tag that consists of multiple portions that attach to one another through a mechanical attachment mechanism, wherein portions of the transponder circuit are encapsulated between layers of each of the multiple portions and become electrically interconnected when the portions are attached to each other, such as when the tag is attached to an object to be identified. In various embodiments, the tag may take the form of two interconnecting sleeve-shaped portions, to interconnected clam-shell-shaped portions, a single clam shell-shaped portion or other suitable configuration. Also, in various embodiments, the modular portions will contain a deformable surface such as foam, silicone or other material to enable the tags to be securely attached to objects of different physical dimensions and shapes. In various other embodiments, the modular tag will attach to an instrument or tool by connecting the modular portions over a handle of the instrument or device, during the later stages of the manufacturing process thereby eliminating the need to embed the tag in the device. Alternatively, the tag may be attached retroactively to existing objects after the objects are manufactured or even after they are in use.

Described above are certain problems associated with the use of RFID tags on medical and/or surgical instruments. One proposed solution to the problem of RFID tags for surgical instruments and other surgical equipment has been to embed RFID transponder tags in a portion of the instrument at the time of manufacture. While ideal in theory, this solution may still suffer from some practical difficulties. First, this approach requires the tool or instrument to have been manufactured with the RFID tag inside. This is undesirable because it complicates the manufacturing process thereby increasing its expense, and it prohibits application of the technology to existing equipment through retrofitting. Second, the individual surgical instruments and equipment often have a high metal content. Because the tag is embedded in the metal, reading of the tag can be difficult due to losses in the metal of the electromagnetic signal. Finally, if the tag stops functioning, the entire instrument must be discarded, or else RF identification techniques can not be utilized with it. Thus, embedding still suffers from some significant technical obstacles. Thus, various embodiments of this invention overcome some of these difficulties through a modular RFID tag that can be securely, but removeably attached over external portions of a surgical instrument or other object to be identified.

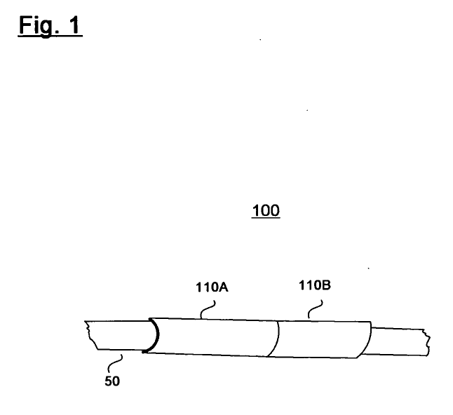

Referring now to FIG. 1, a modular RFID transponder tag 100 is illustrated in accordance with at least one exemplary embodiment of this invention. As shown in FIG. 1, the modular RFID transponder tag 100 comprises a first portion 110A and a second portion 110B that are attached to one another over a portion of an object 50 that has been tagged. In various embodiments, may comprise two tubular shaped portions 110A and 110B that are attached to one another with a mechanical attachment mechanism 115. In various embodiments, the two portions 110A and 110B may be slid over an end of handle or other object to be identified. Furthermore, though not depicted in the Figure, a deformable layer may be formed on the inside surface of the two portions 110A and 110B, pressure from which serves to hold the tag 100 firmly in place. Alternatively, or in combination, each of the first and second portions 110A, 110B may comprise a portion that is made of a flexible, resilient material running the axial length of each portion 110A, 110B to allow the tag 100 to fit objects of differing shapes and diameters.

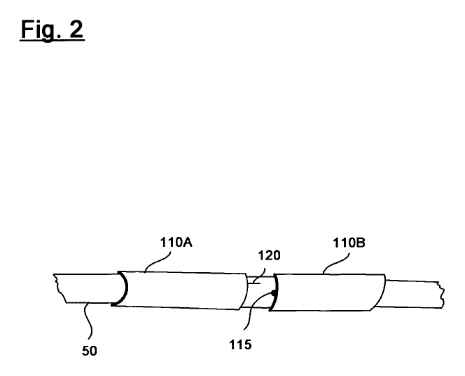

As shown in FIG. 2, the a conductive pin 120 may engage another circuit portion that resides in portion 110B to create a complete transponder circuit when the portions are connected. Though it is not visible in FIGS. 1 and 2, in various embodiments, the transponder circuit, including the processor, may be embedded in one or more layers the first and second portions. However, it should be appreciated that the transponder circuit may appear externally as a bump, recess, a color variation, thickness variation, in either the first or second portions 110A, 110B, or in both portions of the tag 100.

Though shown in FIGS. 1 and 2 as essentially unitary, each of the first and second portions 110A, 110B may, in various embodiments, comprise multiple layers including internal and outer layers made of a material such as rubber, silicone or other suitable material that is flexible, resilient and fluid impervious that serve to protect the transponder circuit from damage and to electrically isolate from conductive surfaces of objects onto which the tag may be attached.

Though the tag's design will permit a single tag to be attached to devices of differing size, within the elastic limits of either the flexible or deformable portions of the tag 100, the tag 100 may be manufactured in a plurality of different diameters and lengths to accommodate objects falling within various size and diameter ranges. The particular dimensions of the tag 100, including the ratio of the radius to the length, are not specific to the invention. In addition, the tag 100 shown in FIGS. 1 and 2 is a generally tubular having a circular cross-section, although any cross-section can be used in the embodiments. Other embodiments include tags whose cross-section varies throughout the length, as well as whose radius varies throughout the length. The term tubular in the context of this application will includes cylindrically shaped structures having a circular cross-section, as well as other shell-type structures having non-circular cross-sections (e.g., oval, rectangular, square, triangular, octagonal, hexagonal, etc.). Those skilled in the art will be capable of designing a suitable tag for any given instrument, using the guidelines provided herein.

Also, though not shown in FIG. 1, the outside surface of either the first or second portions 110A, 110B of the tag 100 may have various visual indicia printed thereon including a numeric indicia, such as a part or item identification number, a textual indicia, such as a product name or product category name, and a brand indicia, such as a manufacturer name of the RFID tag or the item to which the tag is attached. In various exemplary embodiments, all three indicia are utilized. However, in various other embodiments, less then three indicia are utilized. In still further embodiments, more than three indicia are utilized or no indicia at all are utilized. In addition to these embodiments, other embodiments may utilize color coding, bar coding or other optically recognizable indicia. The present invention is compatible with any of the aforementioned indicia schemes.

With continued reference to the modular RFID transponder tag 100 of FIGS. 1 and 2, during practical application, an operator will slide each portion 110A, 110B of the tag 100 over at least a portion of the object to be identified. The portion of the object preferably is slightly larger in diameter than the inside diameter of the tag 100 so that the both friction and the resilient property of the tag 100 will serve to secure the tag to the object. In various embodiments, the RFID transponder tag 100 may be preprogrammed with identification information for the item to which it will be attached. Therefore, once tagged, the item may be wirelessly inventoried by activating the RFID transponder tag 100 using a suitable RF reader device. However, in various other embodiments, the tag may be programmed after attached to its corresponding instrument, tool or other object using a combination reader/writer. Because RFID reader devices are well known in the art, a detailed discussion of such devices has been intentionally omitted. The modular RFID transponder tag 100 according to the preferred embodiment is compatible with any suitable reader devices whether hand held, stationary, fixed or otherwise configured. Moreover, as will be discussed in greater detail herein, because the antenna portion of the tag circuit is located in both the first and second portions 110A, 110B, that circumscribe the tube-like opening defined by the tag 100, read failures due to improper orientation may be greatly reduced and ideally eliminated.

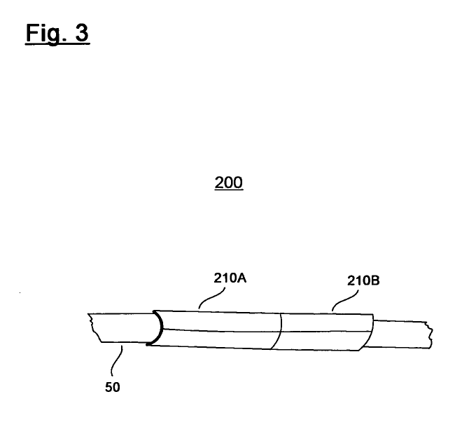

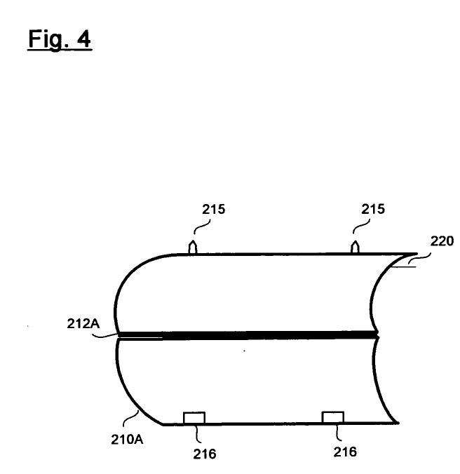

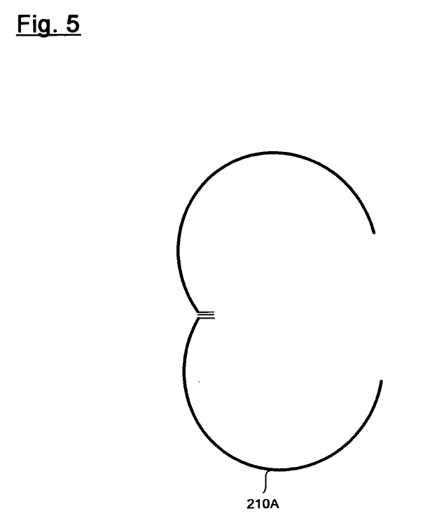

Referring now to FIGS. 3 and 4, perspective views of another modular RFID tag according to at least one embodiment of the invention are depicted. As shown in the Figures, the modular tag 200 according to this embodiment comprises first and second portions 210A, 210B that each wrap around an object 50, snap together using connectors 215, 216, and are also coupled to each other with conductive pin 220. FIG. 4 shows a close up view of the first portion 210A. A flexible hinge portion 212A extending along the main axis of the first portion 210A allows the tag to open and close for each attached to objects. Unlike the tag portions 110A, 110B, depicted in FIGS. 1 and 2, this tag portion 210A does not have to be slid over an object, but rather can be fastened around it using the integral connectors 215, 216. As with the tag 100, a portion of the transponder circuit, such as the antenna portion, may reside in both the first and second portions 210A, 210B of the tag 200 and become interconnected to form a single circuit when the two portions 210A, 210B are joined by the conductive pin 220. In various embodiments, the second portion 210B may have a female connector adapted to receive the conductive pin 220. In various other embodiments, the pin 220 may pierce one or more layers of the second portion 210B in order to contact the antenna portion embedded therein. In this manner, the tag 200 may be easily attached to an instrument or tool handle or other objects. Also, as with tag 100 of FIGS. 1 and 2, the tag 200 may also comprise a deformable material attached to an inside surface that, in addition to the flexible hinge, allows the tag 200 to be attached to shapes slightly larger than the inside diameter of the tag, or objects having a non-circular cross section. FIG. 5 is a side view illustrating the cross sectional shape of the tag portion 210A when it is unattached, that is, open.

As noted herein, the tag according to the various embodiments embodiment may be easily attached to a handle portion of surgical instrument or other hand tool by merely sliding or clasping the tag portions around the distal end of a handle of the surgical instrument or tool up to a location on the handle portion that will minimize obtrusion to the user. In the case of a surgical instrument or tool having a uniformly shaped handle the modular tag according to the various embodiments of the invention will intuitively fits over the handle portion. However, with other instruments, tools or equipment, the modular tag according to the various embodiments of the invention may be attached to a tube, cord, knob, protrusion, or other semi-cylindrical member of an item to be tagged. Alternatively, in various other exemplary embodiments, the modular tag according to the various embodiments of the invention may be attached to an intervening cylindrically shaped tag fastener which is then secured to the item to be tagged using a cable, twist-tie or other suitable attachment means.

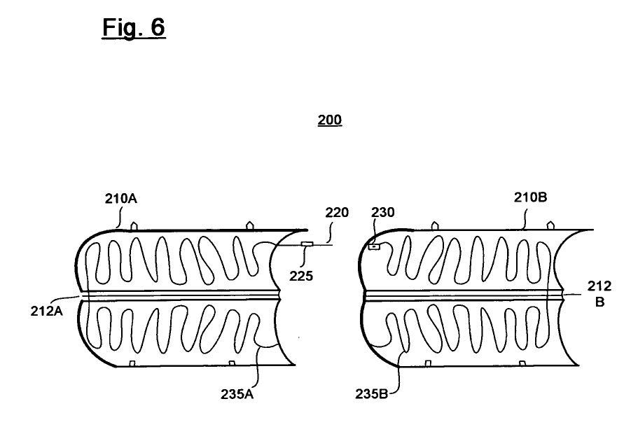

Referring now to FIG. 6, a close up perspective view of a modular RFID tag according to various embodiment of this invention is shown. The tag 200 is similar to that displayed in FIGS. 3-5. As seen in the Figure, the first portion 210A and second portion 210B of the tag 200 have respective wire antenna portions 235A, 235B embedded therein. It should be appreciated that although a wire type antenna 235 is illustrated in the embodiment of FIG. 6, other known types of antenna configurations may be used without departing from the spirit or scope of the invention. The various embodiments of the invention do not depend upon a specific antenna configuration, so long as the antenna is configured to more than 90 degrees of the modular tag to enhance readability. For ease of illustration, the drawing is done to emphasize the presence of the antenna portions 235A, 235B. In practical application, the antenna portions 235A, 235B may be concealed within layers of the tag 200 so that they are not externally visible. In various embodiments, the antenna portions 235A, 235B will extend to both sides of the flexible hinge portions 212A, 212B of both the first portion 210A and second portion 210B. In other embodiments the antenna may only be present on a single side of the flexible hinge portions 212A, 212B. In the embodiment illustrated in FIG. 6, the process of the transponder circuit is configured in a portion 225 of the conductive pin 220, such as, for example, in a mini small outline package (MSOP) configuration. However, in various other embodiments, the tag may be embedded directly in a layer of or otherwise attached to the first portion 210A. Also, in the embodiment of the FIG. 6, the second portion 210B has a connector 230 adapted to receive the conductive metal pin 220, thereby completing the transponder circuit.

In various embodiments, the transponder circuit components may be protected by inner and outer layers. These layers will insulate the transponder circuit from current losses. These layers will also provide a barrier to moisture, heat, cold, and physical contact, so as to protect the transponder circuit from damage. Furthermore, in a preferred embodiment, because the antenna portions 235A, 235B will be embedded along both sides of the flexible hinge joint 212A, 212B, tag reads will be possible irrespective of the tag's orientation.

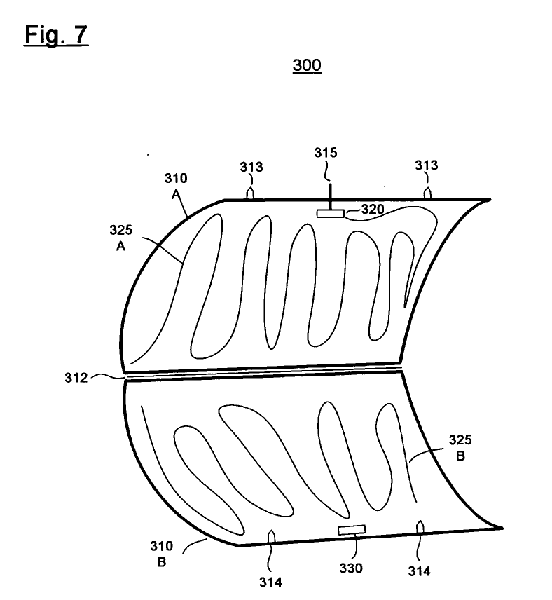

Referring now to FIG. 7, an alternative modular RFID tag according to at least one embodiment of the invention is illustrated. The tag 300 shown in FIG. 3 comprises first and second portions 310A, 310B that are interconnected on one side by a flexible hinge portion 312 and on the other side by reciprocal fasteners 313 and 314 that engage when the tag 300 is closed around a portion of an item to be identified. Also, the conductive pin 315 engages the second portion 325B at the connector area 330 in order to complete the transponder circuit such that the antenna portion of the circuit will completely circumscribe the tag when it is attached to an object. In this way, misreads or non-reads due to incorrect tag-reader orientation will be reduced and ideally eliminated. As with the tags shown in other depicted embodiments, in various embodiments, the tag 300 may include a deformable inside layer of foam, silicone or other suitable material that allows the tag 300 to be securely fastened to objects having a range of circumferences and cross sectional shapes.

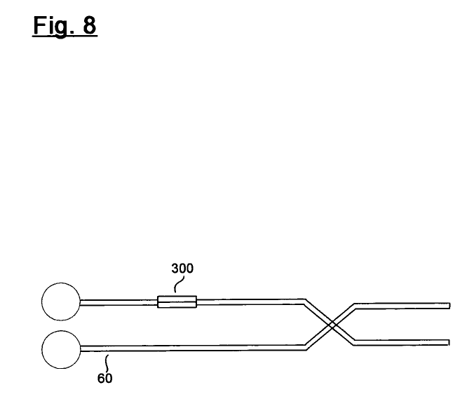

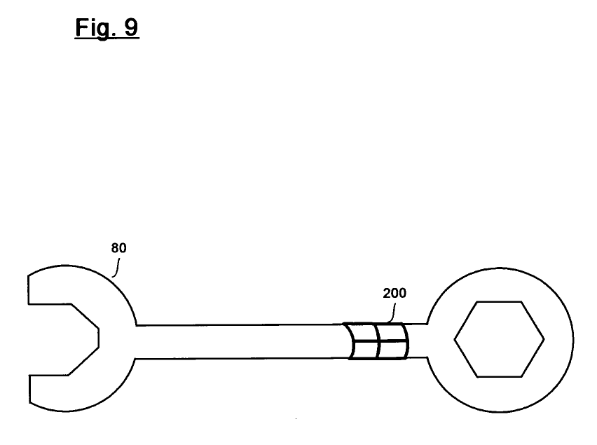

FIGS. 8 and 9 are examples of modular RFID tags according to various embodiments of the invention being attached to a surgical instrument and a hand tool respectively. In FIG. 8, the tag 300 is a tag of the type illustrated in FIG. 7. The tag as been placed on an inside portion of a forceps handle 70. Likewise, in FIG. 9, the tag 200 is a tag of the type depicted in FIGS. 3-5 that has been attached to a handle of a hand tool 80. In either embodiment, the tags may be easily attached, and if necessary, removed. Furthermore, because the antenna of the transponder circuit circumscribes the instrument 70 and tool 80 handles, a read may be performed from nearly any object orientation with respect to the reader making reads faster and more accurate. As noted herein, the modular RFID tag according to the various embodiments of the invention may be utilized with a variety of different surgical instruments, hand tools, and other objects/devices. The specific shape and configuration of the object being identified may lend a preference to one or more embodiments.

The embodiments of the present inventions are not to be limited in scope by the specific embodiments described herein. For example, although many of the embodiments disclosed herein have been described with reference to modular RFID tags used to identify surgical instruments, the principles herein are equally applicable to other aspects radio frequency-based identification. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

What is claimed:

1. A modular RFID tag comprising:
a first portion having a first connecting means;
a second portion having a second reciprocal connecting means; and
an electrical connecting means connecting the first portion to the second portion when the tag is mounted on an item to be identified, and further wherein an RFID transponder circuit is in electrical connection with the electrical connecting means.

2. The RFID tag according to claim 1, wherein each of the first and second portions comprise antenna portions embedded therein, that are interconnected by the electrical connection means.

3. The RFID tag according to claim 2, wherein the electrical connection means is a conductive pin attached to the first portion and adapted to mate with the second portion.

4. The RFID tag according to claim 1, wherein the first and second portions are physically joined by a flexible hinge portion.

5. The RFID tag according to claim 1, wherein each of the first and second portions comprise a flexible hinge portion.

6. The RFID tag according to claim 1, wherein the first connecting means and second reciprocal connecting means comprise mail and female mechanical connectors.

7. The RFID tag according to claim 6, wherein the first connecting means and second reciprocal connecting means comprise a pair of restraining clips and restraining clip brackets respectively.

8. The RFID tag according to claim 1, wherein the first and second portion connect via the first and second connecting means to form a substantially tube-like structure that surrounds a substantially tubular-shaped portion of an object to be identified.

9. The RFID tag according to claim 1, where each of the first and second portions further comprise a deformable inside portion on an object-facing surface of each of the first and second portion, wherein when the first and second portions are mated, the deformable portion deforms to accommodate the shape of an object surrounded by the tag.

10. The RFID tag according to claim 1, wherein the first and second portions further comprise an encapsulating layer that shields the RFID transponder circuit.

11. The RFID tag according to claim 1, wherein each of the first and second portions comprise an embedded antenna.

12. The tag according to claim 1, wherein the RFID transponder circuit comprises an antenna, a microprocessor and a digital memory.

13. The RFID tag according to claim 1, wherein the RFID transponder circuit comprises a mini small outline package (MSOP) for integrated circuits.

14. The tag according to claim 12, wherein the memory is operable to store identification information for at least one item that the tag is associated with.

15. The tag according to claim 1, wherein at least a portion of the RFID transponder circuit is encapsulated in a protective housing.

16. The tag according to claim 8, wherein the protective housing comprises a material selected from the group consisting of plastic, metal, metal alloy and other pressure resistant material.

17. The tag according to claim 1, further comprising one or more visual indicia on an outward facing surface of the substantially cylindrically-shaped structure.

18. The tag according to claim 17, wherein the one or more indicia is selected from the group consisting of a brand owner name, a product name, a category name, a color code, a graphic image, a product identification number, a bar code and combinations thereof.

19. A modular RFID tag comprising:
a first portion having a first connector;
a second portion having a second connector adapted to mate with the first connector member to provide a mechanical connection; and
an RFID transponder circuit; wherein each of the first and second portions comprise an antenna encapsulated therein that is interconnected by a conductive pin attached to the first portion that is adapted to penetrate the second portion when the first and second portions are connected to each other.

20. A modular RFID tag comprising:
a first portion;
a second portion;
a flexible hinge connecting the first portion to the second portion; and
an RFID transponder circuit including a conductive pin, wherein the conductive pin electrically couples antenna portions in the first and second portion to the transponder circuit when the first and second portion are connected to each other.

21. A method of manufacturing a modular RFID tag comprising:
forming a first flexible portion having a first mechanical connector;
forming a second flexible portion having a second reciprocal mechanical connector adapted to mate with the first mechanical connector; and
embedding portions of an RFID transponder circuit in both the first portion and second portions such that when the first portion is connected to the second portion by the first and second connectors, a conductive pin attached to the first portion establishes electrical connection between the two portions of the transponder circuit to form a unitary circuit.
